(19) United States
(12) Patent Application Publication
(10) Pub. No.: US 2015/0006272 A1
(43) Pub. Date: Jan. 1, 2015

(54) INFORMATION PROCESSING DEVICE AND INFORMATION PROCESSING METHOD

(71) Applicant: RAKUTEN, INC., Tokyo (JP)

(72) Inventors: Takemasa YAMADA, Shinagawa-ku (JP); Toshihiko CHIBA, Shinagawa-ku (JP); Hidenori EMURA, Shinagawa-ku (JP); Shigeru ITAHASHI, Shinagawa-ku (JP); Satoshi FUJITA, Shinagawa-ku (JP)

(73) Assignee: RAKUTEN, INC., Tokyo (JP)

(21) Appl. No.: 14/278,033

(22) Filed: May 15, 2014

(30) Foreign Application Priority Data
Jun. 28, 2013 (JP) 2013-136104

(51) Int. Cl. G06Q 30/02

(52) U.S. Cl. CPC G06Q 30/0239; G06Q 30/0222; G06Q 30/0251
USPC 705/14.23; 705/14.39

(57) ABSTRACT

An information processing device according to one embodiment includes a monitoring unit and a providing unit. The monitoring unit detects that a user operates a link to a page of a second shop different from a first shop and accesses to the page of the second shop and then identifies the first shop. The link is on a page of the first shop provided through a network. The link contains information for identifying the first shop and information for identifying the second shop. The providing unit provides the user with information related to a benefit available in the first shop.

### BACKGROUND OF THE INVENTION

1. Field of the Invention

One aspect of the present invention relates to an information processing device and an information processing method for offering benefits to users who accesses a shop through an advertising link.

2. Related Background Art

One of the ways to access a website of a shop from which an item can be purchased online is an advertising link such as a banner. The link is posted on another website. A user who accesses this website recognizes the shop through the advertising link and, if interested, accesses the shop and purchases the item.

Regarding such an advertising link, an electronic shopping mall system that controls advertisements and incentive offer in an electronic shopping mall and the like is disclosed in Patent Literature 1 below. In this system, when a user (consumer) accesses the electronic shopping mall through a banner advertisement and purchases an item, purchase points are awarded to the user, and reward points are awarded to a member which posts the banner advertisement,
[Patent Literature 1] JP 2007-286769 A

### SUMMARY OF THE INVENTION

The above-described Patent Literature 1 has the effect of sending customers from a blog to a shop. On the other hand, as a way to send customers from one shop to another shop on the Internet, an advertisement link to the target shop can be posted on a webpage of the one shop. However, there is a business problem for the one shop that customers leave for another shop. It is therefore difficult to have a shop posting an advertisement link to another shop. Accordingly, a mechanism to give the motivation to post a link to another shop is desired.

An information processing device according to one aspect of the invention includes a monitoring unit configured to detect a that a user operates a link to a page of a second shop different from a first shop and accesses to the page of the second shop and then identify the first shop, the link being on a page of the first shop provided through a network, and the link containing information for identifying the first shop and information for identifying the second shop, and a providing unit configured to provide the user with information related to a benefit available in the first shop.

An information processing method according to one aspect of the invention is an information processing method executed in an information processing device, the method including a monitoring step of detecting that a user operates a link to a page of a second shop different from a first shop and accesses to the page of the second shop and then identifying the first shop, the link being on a page of the first shop provided through a network, and the link containing information for identifying the first shop and information for identifying the second shop, and a providing step of providing the user with information related to a benefit available in the first shop.

In the above aspects, the first shop is identified based on that a user has moved from the first shop to the second shop, and information about a benefit that is available in the first shop is provided to the user (purchaser). By implementing such a mechanism of offering a benefit, a user who has left the first shop once and purchased an item at the second shop is expected to come back to the first shop. This gives the first shop the motivation to post a link to another shop (the second shop).

In the information processing device according another aspect, the providing unit may store benefit information associating the benefit, the first shop and the user as a person allowed to use the benefit into a storage unit and thereby set the benefit to be usable only by the user.

The information processing device according another aspect may further include a link registration unit configured to receive registration of the link from the second shop and then receive selection of the link from the first shop and thereby store link information associating the link, the first shop and the second shop into a storage unit, and provide the first shop with the link containing information for identifying the first shop and information for identifying the second shop.

In the information processing device according another aspect, the link registration unit may provide the first shop with a screen displaying the link received from the second shop, and when receiving selection of the link from the first shop, embed information for identifying the first shop into the link.

The information processing device according another aspect may further include a reimbursement unit configured to calculate a cost of the benefit to be borne, and the monitoring unit may further identify the second shop, the providing unit may store benefit information associating the benefit, the first shop, the second shop, and a usage status of the benefit into a storage unit, and the reimbursement unit may summarize the usage status of the benefit for each pair of the first shop and the second shop based on the benefit information in the storage unit and calculate the amount of payment from the second shop to the first shop based on summation results.

In the information processing device according another aspect, the providing unit may provide information for making the benefit available when the user has finished a purchase procedure in the page of the second shop.

In the information processing device according another aspect, the providing unit may provide the user with the information about a benefit to become available after a lapse of a period where the purchase procedure is cancelable.

According to one aspect of the invention, it is possible to provide a mechanism to give the motivation to post a link to another shop.

### BRIEF DESCRIPTION OF THE DRAWINGS

FIG. 1 is a diagram showing a concept of coupon issuance according to an embodiment.

FIG. 2 is a diagram showing an overall configuration of an information processing system according to an embodiment.

FIG. 3 is a diagram showing a hardware configuration of a server according to an embodiment.

FIG. 4 is a block diagram showing a functional configuration of a server.

FIG. 5 is a diagram showing a concept of a process in a server.

FIG. 6 is a flowchart showing a procedure of coupon issuance.

FIG. 7 is a diagram showing an example of screen transition in an information processing system.

FIG. 8 is a diagram showing a configuration of an information processing program according to an embodiment.

### DESCRIPTION OF THE PREFERRED EMBODIMENTS

An embodiment of the present invention is described hereinafter in detail with reference to the appended drawings. Note that, in the description of the drawings, the same or equivalent elements are denoted by the same reference symbols, and the redundant explanation thereof is omitted.

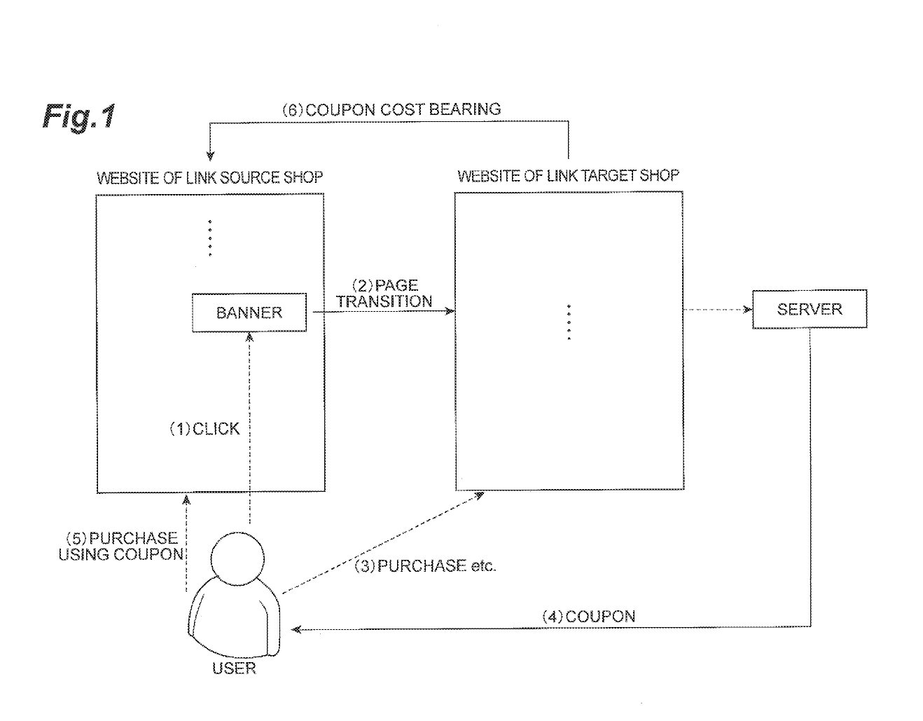

Functions and configuration of an information processing system 1 according to an embodiment are described hereinafter with reference to FIGS. 1 to 4. The information processing system 1 is a computer system that executes processing such as posting a banner advertisement (which is referred to hereinafter simply as “banner”), tracking a user operation on the banner, and offering a benefit to a user. Although this embodiment is based on the assumption that the benefit is a coupon to be used for a discount on the purchase amount, the type of the benefit is not particularly limited. For example, the benefit may be offer of an additional service.

FIG. 1 shows the concept of coupon issuance according to this embodiment. In a webpage of a certain shop, a banner linked to a website of another shop is placed. When a user who accesses the webpage of a link source shop (first shop) clicks on the banner on the site (Step 1), a page transition to a website of a link target shop (second shop) occurs (Step 2). When the user performs an operation of purchase and the like at the link target shop (Step 3), the information processing system 1 issues a coupon to the user (Step 4). This coupon can be used for purchase at least at the link source shop, and the user can purchase an item at a lower price than usual at the link source shop (Step 5). At this point, the link source shop receives a smaller amount of money by the value of the coupon; however, the link target shop hears the difference (Step 6). This means that the link target shop bears the cost of the coupon.

Because the sales of the link target shop in Step 3 result from the user's clicking on the banner on the website of the link source shop, the link source shop contributes to the sales of the link target shop to some degree. Accordingly, in exchange for the contribution, a coupon to enhance purchase at the link source shop is issued with the cost borne by the link target shop in the information processing system 1.

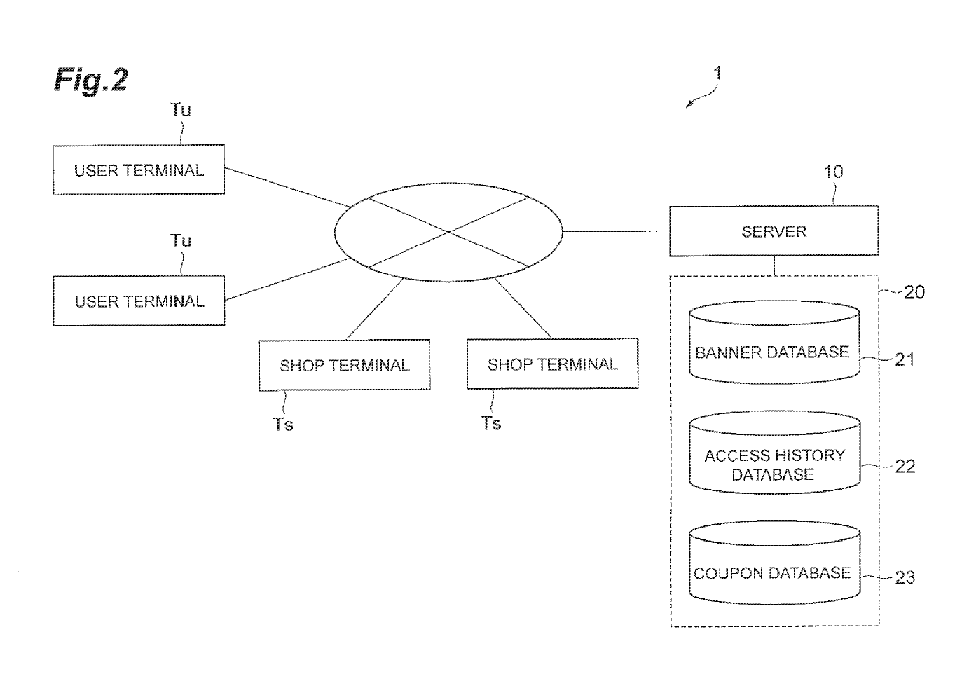

As shown in FIG. 2, the information processing system 1 includes shop terminals Ts, user terminals Tu, a server (information processing device) 10, and databases (storage units) 20. The shop terminals Ts and the user terminals Tu are connected to the server 10 through a network such as the Internet. The server 10 can access the databases 20 through a network such as the Internet or a private line.

The shop terminal Ts is a computer owned by a manager of a shop joining a virtual shopping mall. The variety of the shop terminal Ts is not particularly limited, and it may be a stationary or portable personal computer, or a mobile terminal such as an advanced mobile phone (smart phone), a cellular phone or a personal digital assistant (PDA), for example. The number of shop terminals Ts in the information processing system 1 is not limited.

The user terminal Tu is a computer owned by a user (consumer). Just like the shop terminal Ts, the variety of the user terminal Tu is not particularly limited, and it may be a stationary or portable personal computer, or a mobile terminal such as an advanced mobile phone (smart phone), a cellular phone or a personal digital assistant (PDA), for example. Further, the number of user terminals Tu in the information processing system 1 is also not limited.

The databases 20 are a group of various kinds of databases required in the information processing system 1. The respective databases may be located in any places, and the databases may be put together in one place or located in different places, for example. The respective databases may be managed by the same administrator or different administrators.

The banner database 21 is a device that stores banner information (link information). Each record of the banner information contains the following information.
Banner ID, which is an identifier of the banner;
Link target shop ID, which is an identifier of the link target shop as an advertiser;
URL (Uniform Resource Locator) for leading to a website of the link target shop;
Banner image;
Link source shop ID, which is an identifier of the link source shop as a poster

An access history database 22 is a device that stores access information indicating the access activity at the link target shop of a user who has clicked on a banner. Each record of the access information contains the following information.
Link target shop ID indicating an advertiser of the banner clicked on;
Link source shop ID indicating a poster of the banner clicked on;
User ID, which is an identifier of a user who has clicked on the banner;
Flag indicating whether the user has made a purchase procedure at the link target shop

The flag is represented in binary. For example, the flag is set to “1” when a user performs a purchase procedure and to “0” when a user merely views the website of the link target shop without performing a purchase procedure.

A coupon database 23 is a device that stores coupon information (benefit information) indicating a coupon issued to a user. Each record of the coupon information contains the following information.
Coupon ID identifying a coupon;
Link target shop ID indicating an advertiser of the banner clicked on (a shop bearing the cost of a coupon);
Link source shop ID indicating a poster of the banner clicked on shop at which a coupon is to be used);
User ID, which is an identifier of a user who has clicked on the banner;
Unused points;
Point use history (points consumed (amount of use) for each use and date of use);
Person allowed to use a coupon;
Shop at which a coupon is available

As the information of the person allowed to use a coupon, only the user who has clicked on the banner may be set, or a value indicating that anyone can use the coupon may be set. As the information of the shop at which a coupon available, only the link source shop may be set, only the link source shop and a shop belonging to the same chain may be set, or a value indicating that it is available in any shop may be set.

Specific structures of the databases 20 are not particularly limited. The structure of each database and each record is not limited to those described above, and each database may be normalized or made redundant by an arbitrary policy. For example, because one record of coupon information is generated corresponding to one record of access information, the access history database 22 and the coupon database 23 may be integrated into one database.

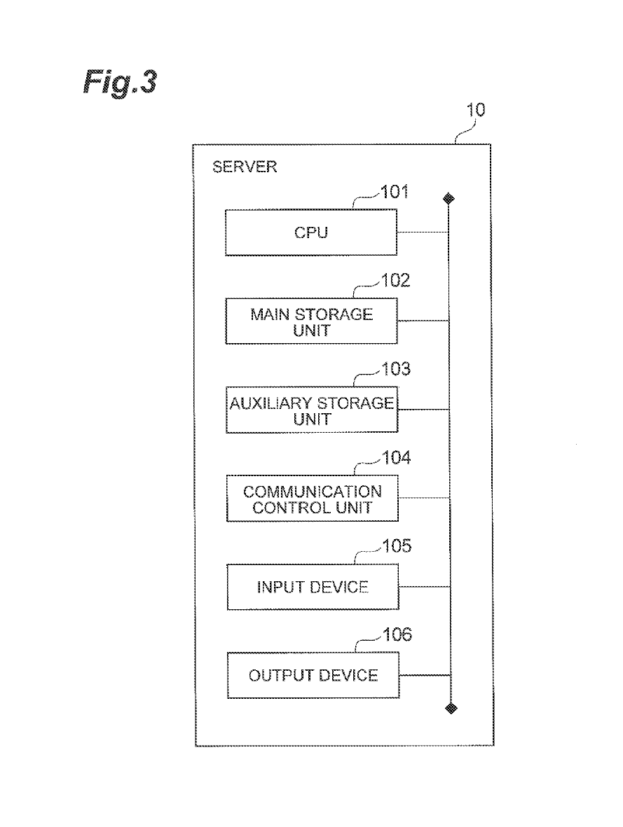

The server 10 is described hereinbelow. The hardware configuration of the server 10 is as shown in FIG. 3. The server 10 includes a CPU 101 that executes an operating system, an application program and the like, a main storage unit 102 such as ROM and RAM, an auxiliary storage unit 103 such as a hard disk and a flash memory, a communication control unit 104 such as a network card or a wireless communication module, an input device 105 such as a keyboard and a mouse, and an output device 106 such as a display.

The functional components of the server 10, which are described later, are implemented by loading given software onto the CPU 101 or the main storage unit 102, making the communication control unit 104, the input unit 105, the output unit 106 and the like operate under control of the CPU 101, and performing reading and writing of data in the main storage unit 102 or the auxiliary storage unit 103. The data and database required for processing are stored in the main storage unit 102 or the auxiliary storage unit 103.

The server 10 may be composed of one computer or a plurality of computers.

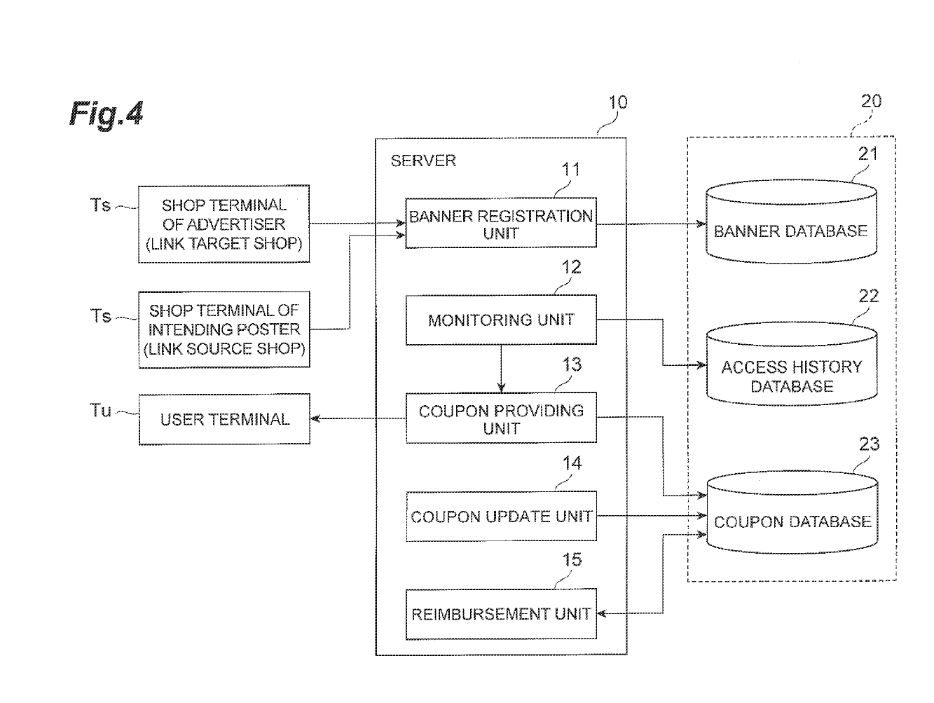

As shown in FIG. 4, the server 10 includes a banner registration unit (link registration unit) 11, a monitoring unit 12, a coupon providing unit 13, a coupon update unit 14, and a reimbursement unit 15 as functional components.

The banner registration unit 11 is a functional component that accepts initial registration of a banner and registration for use of a banner. The banner is a link to another shop which is posted on a webpage of a certain shop, and it functions as an advertisement of the linked shop. A user can access the website of the link target shop by clicking on the banner. The banner can be displayed in various ways without any restrictions in this invention as well.

The banner registration unit 11 mainly has the following functions:
Accept registration of a banner from a shop (advertiser) which desires the banner to be posted on a webpage of another shop;
Accept registration for posting from a shop (intending poster) which desires to post a banner on its webpage.

A shop which desires to register the shop's banner (link target shop) accesses the server 10 through the shop terminal Ts. In response to the access, the banner registration unit 11 transmits a screen for banner registration to the shop terminal Ts. The shop registers a banner image through the registration screen. The banner registration unit 11 registers a banner ID, a link target shop ID and URL for leading to the website of the link target shop in association with the banner image in the banner database 21.

The shop which desires to post a banner of another shop (link source shop) accesses the server 10 through the shop terminal Ts. In response to the access, the banner registration unit 11 transmits a screen for banner selection (banner generation page) the shop terminal Ts. The banner generation page is a webpage that displays banners that have been received from link target shops and registered. The shop selects a desired banner through the banner generation page and posts the banner on its website. The banner registration unit 11 updates the corresponding record in the banner database 21 by associating the link source shop ID with the banner image.

This is described to be more specific. A plurality of banners are displayed on the banner generation page. Each banner is stored in the banner database 21 in association with URL for transitioning to the website of the link target shop. For example, when the ID of a link target shop A is “shop A”, the URL containing the link target shop ID is “http://aaaa.co.jp/code=(blank)&shop_ID=shopA”. At the point of time when the banner is registered, the link source shop ID is blank.

When a shop X with the shop ID “shop X” posts the banner of the shop A on its webpage, the shop X logs in and accesses the banner generation page, and then clicks on the banner of the shop A shown on the page. The banner registration unit 11 inserts the ID of the shop X as the link source shop ID into the blank of the URL associated with the clicked banner of the shop A and thereby generates the URL “http://aaaa.co.jp/code=shopX&shop_ID=shopA” to be embedded in the banner. Further, the banner registration unit 11 writes the ID “shop X” of the shop X as the link source shop ID of the banner information corresponding to the clicked banner. By this process, the banner information indicating the association between the advertiser and the poster is stored in the banner database 21.

Then, the banner registration unit 11 transmits the tag of the banner containing the generated URL to the terminal of the shop X through the Internet or email. A staff of the shop X can thereby post the banner on the webpage of the shop. X using the tag, and the shop X begins to serve as the link source shop. When a user clicks on the banner posted on the webpage of the shop X, the URL “http://aaaa.co.jp/code=shopX&Ashop_ID=shopA” is transmitted to the server 10, and the server 10 can thereby specify the link source shop ID “shop X” and the link target shop ID “shop A”.

The monitoring unit 12 is a functional component that monitors a click operation on a banner by a user. The monitoring unit 12 keeps track of a user's click on the banner and the access activity of the user in the website of the link target shop. Then, the monitoring unit 12 stores the tracking result into the access history database 22.

When the banner is clicked on, the user terminal Tu transmits information about the click operation to the server 10. The monitoring unit 12 receives the information and thereby detects that the user accesses the link target shop through the banner. Then, the monitoring unit 12 identifies the link target shop and the link source shop. There are various methods of identifying those shops as described below, and any of the methods is based on the assumption that the link source shop and the link target shop are associated in advance by the banner information in the banner database 21.

If the link target shop ID and the link source shop ID based on the banner information are written in the UM embedded in the banner using query string, the monitoring unit 12 may identify the link target shop and the link source shop from those IDs.

The mechanism of transmitting the link source shop ID from the user terminal Tu to the server 10 using POST method can be implemented by HTML and JavaScript (trademark or registered trademark; the same applies below) or JavaScript only. In this case, the monitoring unit 12 identifies the shop from the link source shop ID transmitted by the POST method. The link target shop ID can be acquired from the URL embedded in the banner. The setting of the link source shop ID and the link target shop ID is based on the banner information.

If the mechanism of storing the link target shop ID and the link source shop ID based on the banner information into HTTP cookie is implemented, the monitoring unit 12 may identify the link target shop and the link source shop from the information of the cookie transmitted from the user terminal Tu.

If the transition from the website of the link source shop to the website of the link target shop can be managed by HTTP session, the monitoring unit 12 may identify the link target shop and the link source shop from the session ID, the displayed webpage and the banner information.

If the mechanism of storing the link target shop ID and the link source shop ID based on the banner information into web storage is implemented, the monitoring unit 12 may identify the link target shop and the link source shop from the IDs read from the storage and transmitted by the user terminal Tu.

Note that the method of identifying the link target shop and the link source shop is not limited to the above methods, and the monitoring unit 12 may identify the two kinds of shops using an arbitrary method.

After identifying the shops, the monitoring unit 12 monitors the access activity of the user in the website of the link target shop. At this time, the monitoring unit 12 acquires a user ID, which is the identifier of the user. A method of acquiring the user ID is also not limited. For example, the monitoring unit 12 may acquire the user ID that is embedded as a part of session information or may acquire the user ID that is transmitted as a part of a specified HTTP request. The monitoring unit 12 keeps track of the user operation in the website of the link target shop and determines whether the user has performed an item purchase procedure (including requesting a service).

After that, the monitoring unit 12 generates access information based on the acquired information and the determination result. The monitoring unit 12 then stores the access information into the access history database 22 and further outputs it to the coupon providing unit 13.

The coupon providing unit 13 is a functional component that provides a user with information for making the coupon applied to the link source shop available. The coupon providing unit 13 executes the following processing by reference to the input access information.

First, the coupon providing unit 13 determines the details of the coupon based on a specified rule. Note that the coupon providing unit 13 may store information indicating the rule inside in advance or read the rule information from a specified database (not shown).

The coupon may be issued on condition that the user has performed a purchase procedure at the link target shop. Because the cost of the coupon is borne by the link target shop, it is possible to achieve a balance between the link source shop and the link target shop by issuing the coupon on condition that sales and profits are earned in the link target shop. Alternatively, the coupon may be issued both when the user has performed a purchase procedure at the link target shop and when the user has not performed a purchase procedure at the link target shop (when the user has merely viewed the website of the link target shop). However, in order to achieve a balance between the shops, the amount of discount obtained by the coupon is higher when a purchase procedure is done than when not done. Further, the coupon may be issued also when a request for documents, various kinds of reservations, or other request procedures are made, not limited to purchase.

The coupon may be used only by the user indicated by the user ID of the access information or may be used by anyone. Because the user has accessed the access source shop once, the user is likely to have interests in the shop. Accordingly, by limiting the person who can use the coupon to that user, it is possible to provide the coupon to those who are interested in the link source shop.

The coupon that is issued in this embodiment (which is the coupon issued as a result of the user's access to the link target shop through the banner) may be different from or the same as the coupon that is issued as a result of the access without through the banner.

After determining the details (a person allowed to use it, a shop at which it is available and the like) of the coupon, the coupon providing unit 13 notifies information for making the coupon available to the user. The way of notifying the information is not particularly limited. For example, the coupon providing unit 13 may notify the information by email, by transmitting a webpage on which the information appears to the user terminal Tu, or by using any push delivery methods. Note that, in addition to the information for making the coupon available, the server 10 may transmit a webpage announcing offer of a coupon to the user terminal Tu in the website of the link target shop. For example, the coupon providing unit 13 acquires the state of page transition at the link target shop in coordination with the tracking process in the monitoring unit 12 and transmits the announcement page to the user terminal Tu at specified timing.

The information for making the coupon available is a coupon ID that uniquely identifies a coupon to be issued, for example. The user can receive the discount on the purchase amount by entering the coupon ID when purchasing an item at the link source shop next time. Alternatively, the information for making the coupon available may be information required to finally obtain a coupon ID (for example, URL of a webpage for obtaining a coupon).

After the coupon is finally issued to the user, the coupon providing unit 13 generates coupon information and registers it into the coupon database 23. At the time of registration, the coupon providing unit 13 sets the initial value of points as the unused points.

The coupon update unit 14 is a functional component that records the use history of the issued coupon. When a user accesses the website of a shop at which the coupon is available (for example, the link source shop) and performs a purchase procedure using the coupon at that shop, the coupon update unit 14 acquires the used coupon ID and the points consumed. Then, the coupon update unit 14 writes the amount of use and the date of use into the coupon information corresponding to the coupon ID. The use history of the points is thereby stored into the coupon database 23.

The reimbursement unit 15 is a functional component that calculates the cost that arises from use of the coupon by the user. The reimbursement unit 15 performs the following processing at given timing (for example, once a month).

The reimbursement unit 15 calculates the total amount of use of coupons during the summation period (for example, one month) for each pair of the link target shop and the link source shop by referring to the coupon database 23. The summation result is used for payment from the link, target shop and the link source shop.

For example, it is assumed that the reimbursement unit 15 extracts the following use history. Note that, for convenience, the use history is represented by {link target shop, link source shop, amount of use}.
{shop B, shop A, 500 yen};
{shop B, shop A, 200 yen};
{shop B, shop C, 300 yen};
{shop A, shop B, 250 yen};
{shop B, shop C, 100 yen};
{shop C, shop A, 400 yen}

in this case, the summation result for each pair is as follows. Note that, for convenience, each pair is represented by {link target shop, link source shop}.
pair {shop B, shop A} . . . 500+200=700(yen);
pair {shop B, shop C} . . . 300+100=400(yen);
pair {shop A, shop B} . . . 250 yen;
pair {shop C, shop A} . . . 400 yen

The summation result means that the shop B pays 700 yen to the shop A and pays 400 yen to the shop C, the shop A pays 250 yen to the shop B, and the shop C pays 400 yen to the shop A. The costs to be borne can be balanced out by each other between the shops A and B.

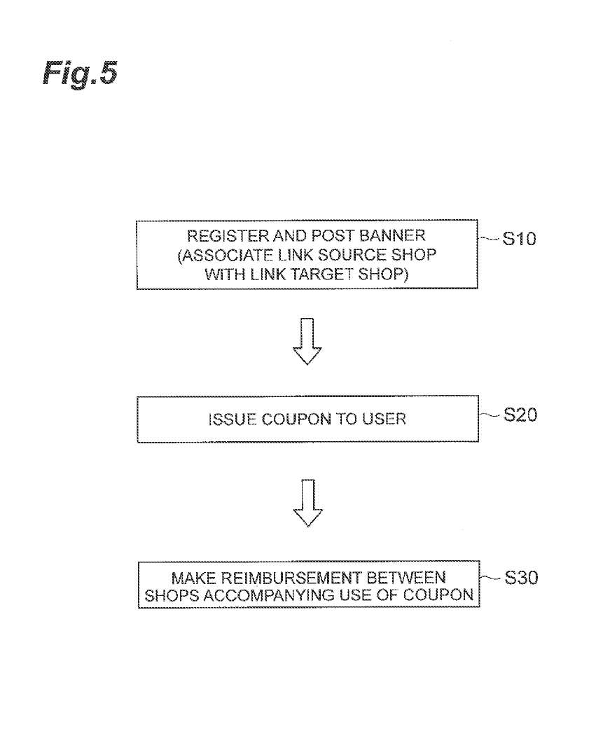

The operation of the server 10 is described and further an information processing method according to this embodiment is described hereinafter with reference to FIGS. 5 to 7.

As shown in FIG. 5, the processing executed by the server 10 is largely divided into three. First, the banner registration unit 11 executes processing related to banner registration and posting, and the link source shop and the link target shop are thereby associated with each other (Step S10). After that, when a user clicks on the banner and performs a purchase procedure at the link target shop, the coupon providing unit 13 issues a coupon to the user (Step S20). After that, when the user performs a purchase procedure at the link source shop using the coupon, the coupon update unit 14 records the use. Then, the reimbursement unit 15 makes reimbursement between the link target shop and the link source shop accompanying the use of the coupon (Step S30).

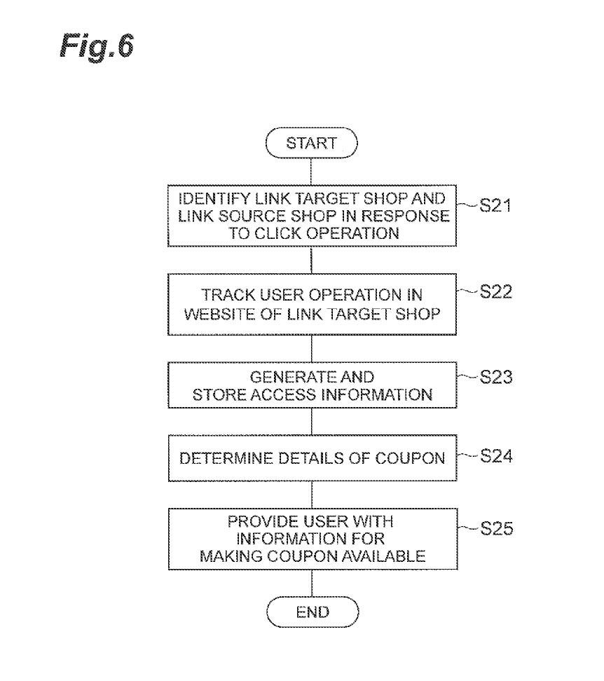

FIG. 6 is a flowchart showing a procedure of monitoring a user operation on a banner and issuing a coupon. First, the monitoring unit 12 identifies the link target shop and the link source shop in response to a user's click operation on a banner (Step S21). Further, the monitoring unit 12 keeps track of the user operation in the website of the link target shop (Step S22). Then, the monitoring unit 12 generates access information based on the acquired information and stores it into the access history database 22 (Step S23). After that, the coupon providing unit 13 determines the details of a coupon (Step S24) and provides information for making the coupon available to the user (Step S25). The coupon is issued by such a process. Steps S21 to S23 correspond to the monitoring step, and Steps S24 and S25 correspond to the providing step.

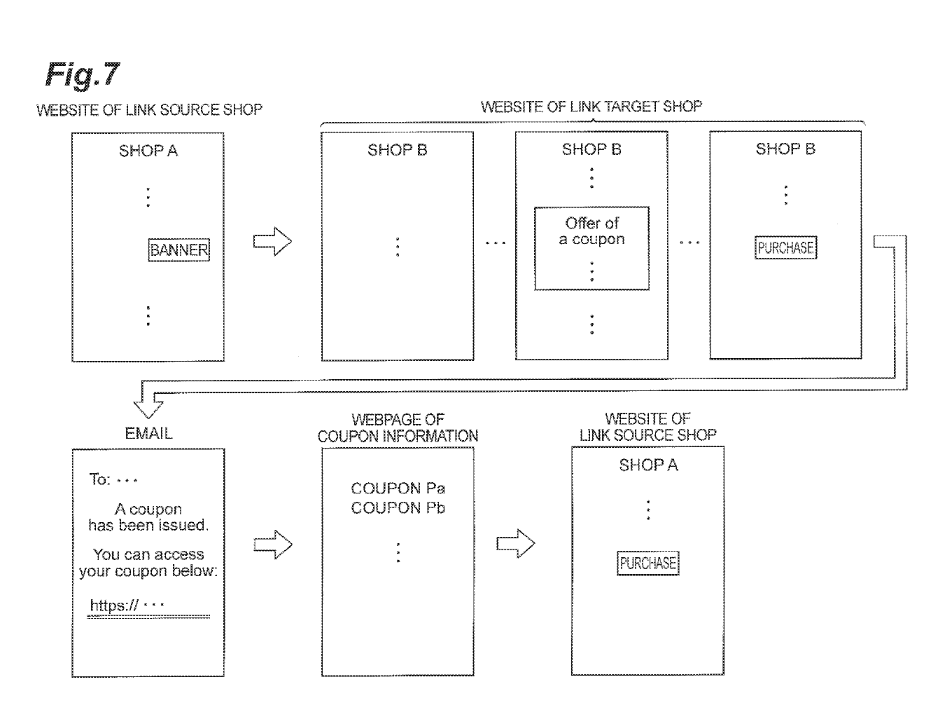

FIG. 7 is a diagram showing an example of screen transition in this embodiment. A user can acquire a coupon and use it according to the procedure as shown therein. In this example, the user clicks on a banner on the webpage of the link source shop A and accesses the website of the link target shop B and then performs an operation to purchase an item. In this example, during the operation, an announcement about a coupon that is available in the shop A is displayed. When the user has finished the purchase procedure at the shop B, the issuance of the coupon is notified to the user via email. The user can access the URL in the body of the email message and see the information about the coupon. After that, the user can access the shop A again and purchase an item using the coupon.

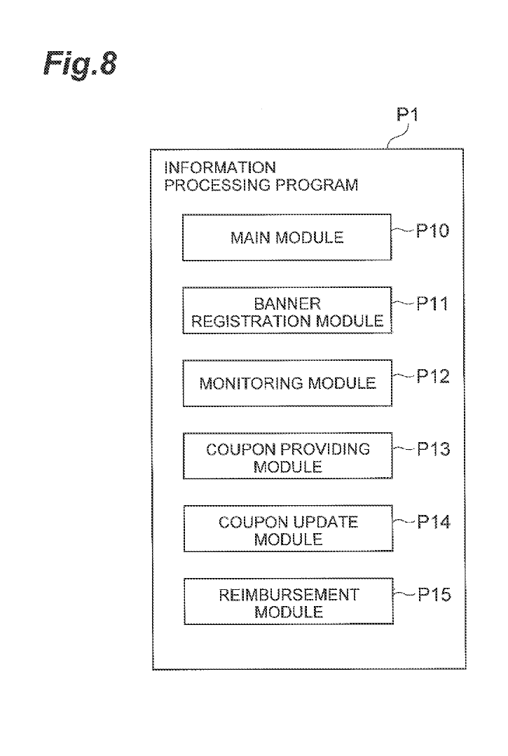

An information processing program P1 that causes a computer to function as the server 10 is described hereinafter with reference to FIG. 8.

The information processing program P1 includes a main module P10, a banner registration module P11, a monitoring module P12, a coupon providing module P13, a coupon update module P14, and a reimbursement module P15.

The main module P10 is a part that exercises control over the coupon management functions. The functions implemented by the banner registration module P11, the monitoring module P12, the coupon providing module P13, the coupon update module P14 and the reimbursement module P15 are respectively the same as the functions of the banner registration unit 11, the monitoring unit 12, the coupon providing unit 13, the coupon update unit 14 and the reimbursement unit 15.

The information processing program P1 is provided in the form of being recorded in a static manner on a recording medium such as CD-ROM, DVD-ROM or semiconductor memory, for example. Further, the information processing program P1 may be provided as a data signal superimposed onto a carrier wave through a communication network.

As described above, according to this embodiment, the link source shop is identified based on that a user has moved from the link source shop to the link: target shop, and information for making a benefit at the link source shop available is provided to the user (purchaser). By implementing such a mechanism of offering a benefit, a user who has left the link: source shop once and purchased an item at the link target shop is expected to come back to the link source shop. In other words, it is possible to send users to each other between the shops. In order to offer a benefit at the link source shop, not a benefit at the link target shop, to a user, it is necessary to identify the link source shop. To solve this technical problem, a user's movement from the link source shop to the link target shop is detected, and the link source shop is identified based on the detection in this embodiment.

The link target shop can expect an increase in sales because users flow into the shop through the banner. The link source shop can expect an increase in sales as well because there is a possibility that users who have once left for the link target shop obtain a coupon available at the link source shop and return to the shop. In this manner, because the scheme of sending users to each other between the shops is established, if the both shops are members of the same virtual shopping mall, for example, the virtual shopping mall becomes active, and an increase in sales can be expected for the virtual shopping mall as a whole. Further, because the user obtains the coupon, the user can benefit from the next purchase. In this manner, this embodiment can bring benefits to all of the customer, the link target shop, the link source shop and the administrator of the virtual shopping mall.

This embodiment is applicable regardless of the business relationship of the link source shop, the link target shop and the coupon administrator, or a domain (business group) to which each of them belongs. For example, both of the link source shop and the link target shop may belong to the same virtual shopping mall, and, in addition, the coupon administrator and the virtual shopping mall may belong to the same business entity or business group. Alternatively, the link source shop and the link target shop may belong to the same business group without belonging to the same virtual shopping mall. Further, the business group may be different among the link, source shop, the link target shop and the coupon administrator. In any case, the cost of the coupon that can be used at the link source shop is borne by the link target shop. The cost bearing (payment) from the link target shop to the link source shop may be made through the coupon administrator, through another business entity, or through no agency.

In this embodiment, when the link source shop (poster) selects a banner registered by the link, target shop (advertiser) and posts the banner on the webpage of the link source shop, the link target shop and the link source shop are stored in the banner database 21 in association with each other. Accordingly, the link source shop and the link target shop can be identified easily using the database.

Further, in this embodiment, the link source shop, the link target shop, and the coupon usage status are stored in the coupon database 23 in association with one another. Accordingly, the amount of payment from the link target shop to the link source shop can be calculated easily using the database.

Hereinbefore, the present invention has been described in detail with respect to the embodiment thereof. However, the present invention is not limited to the above-described embodiment. Various changes and modifications may be made therein without departing from the scope of the invention.

In the above-described embodiment, the server 10 may have a function to prevent coupon fraud. To be specific, the coupon providing unit 13 issues a temporary coupon that is set to be not available during the period where the purchase at the link target shop is cancelable and becomes available only after this period has passed. In this case, the coupon providing unit 13 reads a return period of the item purchased at the link target shop or a scheduled delivery date of the item purchased by the user from a specified database and determines a coupon available period (the date and time when the coupon becomes available). Then, the coupon providing unit 13 generates coupon information further containing the available period and stores it into the coupon database 23. By controlling the coupon in this manner, it is possible to avoid the case where a user makes a purchase procedure at the link target shop and obtains a coupon and then cancels the purchase and uses the coupon.

The place to post a link is not limited to a webpage, and it may be displayed on a screen of a given application program (for example, a program installed, in a given mobile terminal). In this case also, the monitoring unit can keep track of a user operation and a user's access activity using the above-descried technique such as query string. In this case, the link target shop is identified by URI (Uniform Resource Identifier).

A banner to be used a link may be represented only by a character string, without using an image.

Selection of a banner by the link source shop may be made by a method other than using the banner generation page. For example, the link source shop may request a banner to an administrator of the server by telephone or email, and the administrator may send the tag of the banner to the link source shop by email and the like. In this case, the administrator updates the corresponding record in the banner database 21 and thereby associates the link source shop with the link target shop.

1 . . . information processing system, 10 . . . server, 11 . . . banner registration unit (link registration unit), 12 . . . monitoring unit, 13 . . . coupon providing unit, 14 . . . coupon update unit, 15 . . . reimbursement unit, 20 . . . databases, 21 . . . banner database, 22 . . . access history database, 23 . . . coupon database, P1 . . . information processing program, P10 . . . main module, P11 . . . banner registration module, P12 . . . monitoring module, P13 . . . coupon providing module, P14 . . . coupon update module, P15 . . . reimbursement module, Ts . . . shop terminal, Tu . . . user terminal

What is claimed is:

1. An information processing device comprising:
a monitoring unit configured to detect that a user operates a link to a page of a second shop different from a first shop and accesses to the page of the second shop and then identify the first shop, the link being on a page of the first shop provided through a network, and the link containing information for identifying the first shop and information for identifying the second shop; and
a providing unit configured to provide the user with information related to a benefit available in the first shop.

2. The information processing device according to claim 1, wherein the providing unit stores benefit information associating the benefit, the first shop and the user as a person allowed to use the benefit into a storage unit and thereby sets the benefit to be usable only by the user.

3. The information processing device according to claim 1, further comprising:
a link registration unit configured to receive registration of the link from the second shop and then receive selection of the link from the first shop and thereby store link information associating the link, the first shop and the second shop into a storage unit, and provide the first shop with the link containing information for identifying the first shop and information for identifying the second shop.

4. The information processing device according to claim 3, wherein the link registration unit provides the first shop with a screen displaying the link received from the second shop, and when receiving selection of the link from the first shop, embeds information for identifying the first shop into the link.

5. The information processing device according to claim 1, further comprising:
a reimbursement unit configured to calculate a cost of the benefit to be borne,
wherein the monitoring unit further identifies the second shop, and
wherein the providing unit stores benefit information associating the benefit, the first shop, the second shop, and a usage status of the benefit into a storage unit, and
wherein the reimbursement unit summarizes the usage status of the benefit for each pair of the first shop and the second shop based on the benefit information in the storage unit and calculates the amount of payment from the second shop to the first shop based on summation results.

6. The information processing device according to claim 1, wherein the providing unit provides information for making the benefit available when the user has finished a purchase procedure in the page of the second shop.

7. The information processing device according to claim 6, wherein the providing unit provides the user with the information about a benefit to become available after a lapse of a period where the purchase procedure is cancelable.

8. An information processing method executed in an information processing device, the method comprising:
a monitoring step of detecting that a user operates a link to a page of a second shop different from a first shop and accesses to the page of the second shop and then identifying the first shop, the link being on a page of the first shop provided through a network, and the link containing information for identifying the first shop and information for identifying the second shop; and
a providing step of providing the user with information related to a benefit available in the first shop.
